(19) United States
(12) Patent Application Publication
(10) Pub. No.: US 2011/0136661 A1
(43) Pub. Date: Jun. 9, 2011

(54) Non-hygroscopic stabilized catalyst for the in-situ generation of sulfate free radicals

(76) Inventor: Roy W. Martin, Downers Grove, IL (US)

(21) Appl. No.: 12/653,003

(22) Filed: Dec. 7, 2009

(51) Int. Cl. B01J 31/18; B01J 27/232; B01J 21/08; B01J 23/00; B01J 23/75

(52) U.S. Cl. 502/167; 502/162; 502/174; 502/240; 502/300

(57) ABSTRACT

This invention relates to methods for producing, and the resulting compositions comprising non-hygroscopic stabilized catalyst for use with peroxysulfates for the in-situ generation of sulfate free radicals in recreational water.

### FIELD OF INVENTION

This invention relates to methods for producing, and the resulting compositions comprising non-hygroscopic stabilized catalyst for use with peroxysulfates for the in-situ generation of sulfate free radicals in recreational water. The non-hygroscopic compositions disclosed eliminate the clumping of formulations that comprise both transition metal catalyst and peroxysulfates, and the staining that occurs resulting from rapid oxidation of unstabilized catalyst and subsequent precipitation of metal oxides.

### BACKGROUND

Catalytic decomposition of monopersulfate and persulfate leads to the formation of very powerful and useful sulfate free radicals. These radicals have the ability to oxidize compounds that are resistant to oxidation from the precursors monopersulfate and persulfate.

The use of catalyzed monopersulfate has proven very useful for the treatment of recreational water. The organic based contaminants in the presence of chlorine form chlorinated decomposition byproducts that linger and accumulate, resulting in the various symptoms including: irritation, odors, corrosion of equipment, reduced ORP, and reduced disinfection rates.

The use of catalyzed monopersulfate and persulfates has been shown to effectively eliminate these symptoms by dramatically reducing the formation and accumulation of the halogenated decomposition byproducts.

Numerous catalyst have been shown to provide the benefit of forming sulfate free radicals, however the efficiency of cobalt and ruthenium based catalyst when used with monopersulfate compounds is far greater than iron, manganese and others.

While the benefits of cobalt catalyzed monopersulfate are apparent, the use of un-stabilized catalyst has proven to bring along some unwanted problems. Un-stabilized catalyst such as cobalt sulfate allows for the rapid oxidation of the cobalt catalyst, and the subsequent precipitation of the cobalt oxide. This forms a grey to black stain on the shell of the pool.

Furthermore, while addition of chelants such as EDTA and DTPA sold by Dow Chemical under the trade names Versene and Versenex reduce the potential for the problem, in many instances such as in the case of over-feed, feeder failure, or misapplication of the treatment, the staining problems result.

In order to effectively eliminate the staining potential of the catalyst when used in conjunction with peroxysulfate precursors and for that matter halogen based disinfectants, the catalyst needs to be chemically bound by the chelant. To ensure this process occurs before distribution into the oxidant treated pool water, the catalyst and chelant needs to be properly reacted prior to addition.

The complexing of the catalyst and chelant can be successfully achieved by combining the two compounds in an appropriate ratio, allowing sufficient time to react, then either dried to form a powder, or used as a liquid source of chelated catalyst.

Examples of proper ratios and processing will be addressed at a later time. The dried powder form is better suited for dry compositions that combine the catalyst and monopersulfate and/or persulfate precursor.

The powdered form is ideal for compositions that mix the catalyst and precursor together to form a combined composition. However, it has been found that the powder is very hygroscopic. When exposed to relative humidity the powder clumps and can become extremely wet. When formulated with potassium monopersulfate for example, severe clumping resulted even when relatively high levels (4 wt %) of anti-caking agents where applied. In many instances the clumping was so severe the entire contents of the container became a solid mass, requiring physical breaking or reprocessing.

Anti-caking agents are commonly used to reduce clumping resulting from hygroscopic compounds.

Magnesium carbonate is commonly applied to potassium monopersulfate at approximately 1-4 wt % for this very reason. Fumed silica is another example of a very effective anti-caking agent applied to materials to reduce moisture pick-up and subsequent clumping. However, it has been found that when these anti-caking agents are used at recommended concentrations, they do not provide adequate protection from moisture gain and clumping. Anti-caking agents such as magnesium carbonate light, fumed silica and talc are applied at recommend dosages of about 0.5 wt % to 4 wt %. However it has been found that the preferred catalyst is not adequately protected from moisture adsorption by simply including these agents in concentrations recommended in the manufacturer's literature.

### SUMMARY

In one aspect, the invention is a dry non-hygroscopic transition metal-polydentate catalyst that can be formulated with or applied separately with either monopersulfate based or persulfate based precursors for the treatment of recreational water.

In another aspect, the invention is a dry non-hygroscopic transition metal-aminocarboxylate catalyst that can be formulated with or applied separately with either monopersulfate based or persulfate based precursors for the treatment of recreational water.

In another aspect, the invention is a dry non-hygroscopic cobalt-polydentate catalyst that can be formulated with or applied separately with either monopersulfate based or persulfate based precursors for the treatment of recreational water.

In another aspect, the invention is a dry non-hygroscopic ruthenium-polydentate catalyst that can be formulated with or applied separately with either monopersulfate based or persulfate based precursors for the treatment of recreational water.

In another aspect, the invention is a dry non-hygroscopic transition metal-aminocarboxylate catalyst that can be formulated with or applied separately with either monopersulfate based or persulfate based precursors for the treatment of recreational water that also comprises an acrylate polymer.

### DETAILED DESCRIPTION OF THE EMBODIMENT(S)

Various compositions and methods of the invention are described below. Although particular compositions and methods are exemplified herein, it is understood that any of a number of alternative compositions and methods are applicable and suitable for use in practicing the invention.

As used herein, the term “Recreational water” is used in reference to aqueous systems used for recreational purposes and is exemplified by: swimming pools, spas, hot tubs, waterparks, wading pools, feature pools, and any number of various aqueous systems used by mammals for recreation and entertainment.

As used herein, the term “Stabilized” is used in reference to catalyst to describe a transition metal that has at least some portion of its coordination sites bound by a chelating agent that increases the solubility of the resulting chelant-transition metal complex.

As used herein, the term “chelant” is used in reference to an organic compound that has multiple coordination sites that form complexes with metal ions to form water soluble complexes thereby reducing the tendency to precipitate.

As used herein, the term “Polydentate” is used in reference to an organic compound that has at least three coordination sites that complex with a transition metal ion. Examples include but are not limited to aminocarboxylates such as EDTA and DTPA, and phosphonates such as HEDP.

As used herein, the term “Aminocarboxylate” is used in reference to a family of compounds used to chelate metal ions. Examples include: ethylenediaminetetraacetic acid (EDTA), nitrilotriacetic acid (NTA), diethylenetriaminepentacetic acid (DTPA), N-[hydroxethyl]-ethylenediaminetriacetic acid, and their sodium salts. All are sold under the trade names Versene, Versenol and Versenex by Dow Chemical.

As used herein, the term “Monopersulfate” is used in reference to a composition that when combined with an aqueous solution contributes HSO₅⁻. An example of a monopersulfate is potassium monopersulfate sold by United Initiators under the trade name Caroat®.

As used herein, the term “Persulfate” is used in reference to a composition that when combined with an aqueous solution contributes S₂O₈⁼. Examples of persulfates include sodium persulfate and potassium persulfate.

As used herein, the term “Precursors” is used in reference to compounds that when reacted with a catalyst decomposes to form sulfate free radicals.

As used herein, the term “Peroxysulfate” is used in reference to a compositions that when combined with an aqueous solution contributes S₂O₈⁼ and/or HSO₅⁻.

As used herein, the term “Sulfate free radical” is used in reference to a sulfate compound that is missing at least one electron. The general formula for a sulfate free radical can be written as SO₄\dot{−} wherein the dot above the negative sign (\dot{−}) represents a missing electron.

As used herein, the term “anti-caking agent” is used in reference to compounds that coat particles and reduce the tendency for the particles to agglomerate, thereby keeping the particles free-flowing.

The invention discloses compositions and methods for producing a non-hygroscopic stabilized catalyst for the in-situ generation of sulfate free radicals from peroxysulfate precursors in recreational water. The application of the disclosed invention eliminates the clumping and solidifying of formulation comprising both transition metal catalyst and peroxysulfate precursors, and eliminates the staining resulting from the rapid oxidation and precipitation of unstabilized catalyst.

The preferred chelants have at least 6 coordination sites. Examples include ethylenediaminetetraacetic acid (EDTA), diethylenetriaminepentacetic acid (DTPA), N-[hydroxethyl]-ethylenediaminetriacetic acid, their sodium acetate surrogates and combinations thereof. All are sold under the trade names Versene, Versenol and Versenex by Dow Chemical.

An alternative chelant may include but is not limited nitrilotriacetic acid and its sodium salt also sold by Dow Chemical under the trade name Versene. Phosphonates such as HEDP (Hydroxyethylidene biphosphonate) sold by Solutia under the trade name Dequest could also be used for treatments where adequate dilution of the catalyst prior to contact with oxidants will occur.

Addition of other chelating, sequestering, and dispersing agents can also be included in the catalyst mix. Examples include various phosphonates such as HEDP (Hydroxyethylidene biphosphonate) as well as polymers that comprise at least a carboxyl group. Of particular benefit is the inclusion of an acrylate terpolymer such as those sold under the trade name Carbosperse and exemplified by Carbosperse K-797D sold by Lubrizol. Carbosperse terpolymers have been shown to improve dispersion of precipitated catalyst, and excellent stability in oxidant environments. The use of terpolymers provides another layer of protection from staining resulting from precipitation of metal oxides.

Anti-caking agents are exemplified by magnesium carbonate light, fumed silica and talc. Magnesium carbonate light is the preferred anti-caking agent since it will dissolve in acidic solution such as in the case of potassium monopersulfate.

### Catalyst for Monopersulfate Based Precursors

The transition metal catalyst can comprise at least one of: cobalt, ruthenium, iron, cerium, vanadium, manganese, and nickel. The preferred catalyst comprises cobalt or ruthenium. The transition metal catalyst shall be a water soluble form or converted into a water soluble form in order to produce the transition metal-chelant complex. Examples include but are not limited to various salts exemplified by cobalt sulfate and cobalt chloride, as well as ligand bound forms exemplified by cobalt acetate.

### Catalyst for Persulfate Based Precursors

The transition metal catalyst can comprise at least one of: cobalt, silver, copper, iron, and manganese.

### Method for Producing the Chelant-Catalyst Composition

The chelant and transition metal catalyst are supplied as either solid and/or liquid. The chelant and catalyst are combined to form an aqueous solution to provide a stoichiometry of at least 0.75:1 based on active chelant to elemental metal respectively. The preferred stoichiometry of active chelant to elemental metal is at least 1:1. Substoichiometric ratios of chelant to transition metal can be used in cases where rapid dilution will take place since even with substoichiometric ratios, some of the coordination sites of the chelant will bridge multiple metal ions and provide at least temporary stabilization of more than one metal ion. Once the solution is homogenous, the solution is spray dried in a fluidized spray drier to produce a powder. Spray drying is a commonly used technique for producing powders and granules. An example of a supplier of spray drying equipment is GEA Process Engineering Inc., Columbia, Md. 21045.

The collected powder is then mixed with at least 40 wt % of anti-caking agent. The preferred anti-caking agent is magnesium carbonate light. An example of magnesium carbonate light is available through Akrochem Corp. located in Akron, Ohio and sold under the trade name Elastocarb®.

An optional acrylate terpolymer dispersant exemplified by Carbosperse K-797D can be added and mixed.

The resulting powder is non-hygroscopic and can be combined directly with monopersulfate or persulfate precursors, or added separately for the treatment of recreational water.

### Test 1—Hygroscopic Test

1400 ml of Versenex 80 (1820 grams) obtained from Dow Chemical was added to 2000 ml of water and mixed using a magnetic stirrer in a 3500 ml beaker. To this, 255 grams of cobalt sulfate obtained from OMG located in Westlake, Ohio was added and mixed until dissolved. The solution was dark purple in color but had no observable suspended solids.

The solution was packaged and sent to Aveka located in Woodbury, Minn. where the solution was spray dried into a fine pink powder.

A one gram sample of powder was placed on a piece of paper and allowed to sit undisturbed for approximately 24 hours. Within about 1 hour the sample was purple on all exposed edges, and within several hours the sample was purple throughout. After 24 hours the sample has absorbed so much moisture that the paper it was resting on was wet and purple. Two 1-gram samples were prepared by treating each with 20 wt % anti-caking agent in a small glass vial and shaking vigorously until the sample appeared uniform throughout. Sample 1 was treated with 20 wt % fumed silica sold under the trade name CAB-O-SM M-5. Sample 2 was treated with 20 wt % Magnesium Carbonate light obtained through Sigma-Aldrich. After 24 hours both samples had some clumping. However sample 1 had darkened to a light purple while sample 2 remained pink. While moving the samples with a small plastic spatula, the clumping of both samples was evident however, sample 1 coated with fumed silica produced larger and harder clumps.

Two additional 1-gram samples were prepared like those previously stated, however this time magnesium carbonate light was applied to both. The wt % of magnesium carbonate light was increased to 40 wt % for sample 3 and 60 wt % for sample 4.

After 24 hours, sample 3 had a slight detection of clumping. However the clumps upon contact with the spatula crumbled. The sample 3 remained pink in color. Sample 4 however remained as a fine powder.

Both samples 3 and 4 where allowed to remain exposed to room conditions for 14 additional days with periodic visual inspection. Both samples remained pink with sample 3 having only minor clumping which again crumbed easily upon contact. Sample 4 remained as a powder with a light pink color.

Sample 5 was prepared by combining 1 gram of sample with 0.28 grams of Carbosperse K-797D and 1.92 grams of Magnesium Carbonate light and mixed vigorously until uniform. This sample was exposed to room conditions for 14 days and remained as a powder with light pink color.

### Test 2—Clumping And Staining

Permission was obtained from Truox, Inc. located in McClellan, Calif. to trial the non-hygroscopic catalyst on one of the facilities that had experienced staining resulting from their product called Purolyte Plus which comprised potassium monopersulfate combined with cobalt sulfate that had been pre-coated with a stoichiometric concentration of DTPA acid manufactured by Dow Chemical.

Purolyte Plus which is fed automatically through a feeder had experienced clumping which jammed the feeder as well as staining of the pool floor and walls. The Purolyte Plus proved very effective at controlling unwanted combined chlorine, but the higher feed-rates caused undesirable side effects. Within days of initiating feed of the old Purolyte Plus the bottom of the pool began to darken.

The location where the trial took place has a 15,000 gallon pool. Some 100-150 kids visit to learn how to swim. The high bather load often required aggressive feed (1.5-2 lbs per day) of the Purolyte Plus to control combined chlorine levels. Prior to starting the trial, the pool was acid washed to remove the old stains.

Prior to making the new Purolyte Plus for the trial, a premix was produced comprising: 23.81 wt % Co-DTPA, 69.84 wt % MgCO3, 6.35 wt % Carbosperse K-797D

The premix was combined with potassium monopersulfate purchased from United Initiators under the trade name Caroat® to produce 100 lbs of Purolyte Plus product comprising:

87 wt % Caroat, 3 wt % Premix, 8 wt % soda ash, 2 wt % MgCO3

The new Purolyte Plus was implemented at the location. The feed-rate was initially 1.5 lbs per day for the first week. When no signs of discoloration appeared, the feed-rate was gradually increased to 3.0 lbs per day. The combined chlorine levels were substantially reduced and air quality greatly improved. No clumping of the Purolyte Plus occurred. More importantly, no staining occurred even with a feed-rate of over 30% higher than the maximum used with the older Purolyte Plus treatment.

The combination of producing a chelant-catalyst complex, combined with proper selection and quantities of anti-caking agent resulted in a non-hygroscopic catalyst composition that has eliminated all of the problems encountered while providing all of the desired benefits resulting from in-situ generation of sulfate free radicals.

I claim:

1) A composition comprising a non-hygroscopic transition metal-polydentate catalyst for use with at least one of a monopersulfate and persulfate precursors for the in-situ generation of sulfate free radicals in recreational water, the said composition comprising:
producing a transition metal-polydentate complex in an aqueous solution, drying the said complex to produce a dry transition metal-polydentate catalyst, mixing said catalyst with at least 40 wt % of an anti-caking agent; and
wherein, the polydentate and transition metal are combined to form a complex in an aqueous solution to provide a stoichiometric ratio of at least 0.75:1 based on active polydentate to elemental transition metal respectively.

2) The composition of claim 1, wherein the anti-caking agent is selected from at least one of magnesium carbonate light, fumed silica, and talc.

3) The composition of claim 1, wherein the polydentate is selected from at least one of aminocarboxylate and phosphonate.

4) A composition comprising a non-hygroscopic cobalt-aminocarboxylate catalyst for use with a monopersulfate precursor for the in-situ generation of sulfate free radicals in recreational water, the said catalyst comprising:
producing a cobalt-aminocarboxylate complex in an aqueous solution, drying the said complex to produce a dry cobalt-aminocarboxylate catalyst, mixing said cobalt-aminocarboxylate catalyst with at least 40 wt % of an anti-caking agent; and
wherein, the aminocarboxylate and cobalt are combined to form a complex in an aqueous solution to provide a stoichiometric ratio of at least 0.75:1 based on active aminocarboxylate to elemental cobalt respectively; and
wherein, the composition comprises from 20-60 wt % cobalt-DTPA, 40-80 wt % magnesium carbonate light, and where the total composition equals 100 wt %.

5) The composition of claim 4, wherein the aminocarboxylate comprises at least one of DTPA and EDTA.

6) A composition comprising a non-hygroscopic cobalt-DTPA catalyst for use with a monopersulfate precursor for the in-situ generation of sulfate free radicals in recreational water, the said composition comprising:
producing a cobalt-DTPA complex in an aqueous solution, drying the said complex to produce a dry cobalt-DTPA catalyst, mixing said catalyst with magnesium carbonate light and an acrylate terpolymer; and
wherein, the DTPA and Cobalt are combined to form a complex in an aqueous solution to provide a stoichiometric ratio of at least 0.75:1 based on active DTPA to elemental Cobalt respectively; and
wherein, the composition comprises from 5-40 wt % cobalt-DTPA, 40-80 wt % magnesium carbonate light, 1-20 wt % acrylate terpolymer, and where the total composition equals 100 wt %.
